(19) United States
(12) Patent Application Publication
(10) Pub. No.: US 2011/0075198 A1
(43) Pub. Date: Mar. 31, 2011

(54) CONTROL APPARATUS, IMAGE FORMING SYSTEM, COMPUTER READABLE MEDIUM STORING PROGRAM, AND CONTROL METHOD

(75) Inventor: Ryo AGEHAMA, Kawasaki-shi (JP)

(73) Assignee: FUJI XEROX Co., Ltd., Tokyo (JP)

(21) Appl. No.: 12/701,609

(22) Filed: Feb. 8, 2010

(30) Foreign Application Priority Data
Sep. 25, 2009 (JP) 2009-220781

(51) Int. Cl. G06F 3/12

(52) U.S. Cl. 358/1.15

(57) ABSTRACT

A control apparatus includes: an execution controller that links a plurality of print commands with each other, makes an image forming apparatus execute the linked print command as a single print command, cancels execution of a cancel target print command and an unexecuted print command scheduled to be executed after the cancel target print command when a cancel command is issued to some of the plurality of print commands belonging to the linked print command, and then makes the image forming apparatus execute the unexecuted print command; and a display controller that creates status information representing an execution state of the plurality of print commands and displays the status information on a display. The display controller distinguishably displays, as the status information concerning the unexecuted print command, at least a first status waiting for execution of the unexecuted print command and a second status waiting for restart of execution of the unexecuted print command after execution of the unexecuted print command has been canceled in connection with cancellation of the cancel target print command.

### CROSS-REFERENCE TO RELATED APPLICATIONS

This application is based on and claims priority under 35 USC 119 from Japanese Patent Application No. 2009-220781 filed on Sep. 25, 2009.

### BACKGROUND

### Technical Field

The present invention relates to a control apparatus, an image forming system, a computer readable medium storing program, and a control method.

### SUMMARY

According to an aspect of the present invention, there is provided a control apparatus including: an execution controller that links a plurality of print commands with each other, makes an image forming apparatus execute the linked print command as a single print command, cancels execution of a cancel target print command and an unexecuted print command scheduled to be executed after the cancel target print command when a cancel command is issued to some of the plurality of print commands belonging to the linked print command, and then makes the image forming apparatus execute the unexecuted print command; and a display controller that creates status information representing an execution state of the plurality of print commands and displays the status information on a display, wherein the display controller distinguishably displays, as the status information concerning the unexecuted print command, at least a first status waiting for execution of the unexecuted print command and a second status waiting for restart of execution of the unexecuted print command after execution of the unexecuted print command has been canceled in connection with cancellation of the cancel target print command.

### BRIEF DESCRIPTION OF THE DRAWINGS

Exemplary embodiments of the present invention will be described in detail based on the following figures, wherein:

FIG. 1 is a diagram showing the overall configuration of an image forming system according to a first exemplary embodiment;

FIG. 2 is a diagram showing an example of the configuration of an image forming apparatus according to the first exemplary embodiment;

FIG. 3 is a diagram showing an example of a hardware configuration of computers for implementing a print server and a client terminal according to the first exemplary embodiment;

FIG. 4 is a diagram showing an example of the functional configuration of the print server according to the first exemplary embodiment;

FIG. 5 is a diagram showing an example of the configuration of job managing information used in the first exemplary embodiment;

FIG. 6 is a diagram showing an example of the configuration of a status report created on the basis of the job managing information of FIG. 5;

FIG. 7 is a flowchart showing the procedure of generating job managing information by a job managing unit of the print server according to the first exemplary embodiment;

FIG. 8 is a flowchart showing the operation of the job managing unit and a display controller when a cancel command of the print job is received;

FIG. 9 is a flowchart showing the content of restarting processing represented by step 809 of FIG. 8;

FIG. 10 is a diagram showing an update operation of the job managing information and the status report in the first exemplary embodiment, and also showing a state when “Job1” is received;

FIG. 11 is a diagram showing the update operation of the job managing information and the status report in the first exemplary embodiment, and also showing a state when “Job2” is received;

FIG. 12 is a diagram showing the update operation of the job managing information and the status report in the first exemplary embodiment, and also showing a state when “Job3” to “Job6” are received;

FIG. 13 is a diagram showing the update operation of the job managing information and the status report, and also showing a state when an output completion notification of a first page is received;

FIG. 14 is a diagram showing the update operation of the job managing information and the status report, and also showing a state when an entry of “Job1” is deleted from the job managing information;

FIG. 15 is a diagram showing the update operation of the job managing information and the status report, and also showing a state when a cancel command for “Job3” and “Job5” are received;

FIG. 16 is a diagram showing the update operation of the job managing information and the status report, and also showing a state when an output completion notification of a third page is received;

FIG. 17 is a diagram showing the update operation of the job managing information and the status report, and also showing a state when an entry of “Job2” is deleted from the job managing information;

FIG. 18 is a diagram showing the update operation of the job managing information and the status report, and also showing a state when entries of “Job3” and “Job5” are deleted from the job managing information;

FIG. 19 is a diagram showing the update operation of the job managing information and the status report, and also showing a state when a print job having a job ID of “Job6” is received;

FIG. 20 is a diagram showing the update operation of the job managing information and the status report, and also showing a state when an entry of “Job4” is deleted from the job managing information;

FIG. 21 is a diagram showing the update operation of the job managing information and the status report, and also showing a state when the status of “renJob1” is changed to “under processing”;

FIG. 22 is a diagram showing an example of the functional configuration of the print server according to a second exemplary embodiment;

FIG. 23 is a flowchart showing the operation of a job managing unit and a display controller when a cancel instruction of a print job is received in the second exemplary embodiment;

FIG. 24 is a flowchart showing the content of restart processing in step 2310 of FIG. 23;

FIG. 25 is a diagram showing an update operation of job managing information and a status report in the second exemplary embodiment, and also shows a state when entries of all jobs are deleted from the job managing information;

FIG. 26 is a diagram showing an update operation of job managing information and a status report in the second exemplary embodiment, and also shows a state when “Job4” and “Job6” are newly registered in the job managing information; and

FIG. 27 is a diagram showing the update operation of the job managing information and the status report in the second exemplary embodiment, and also shows a state when the entry of “Job4” is deleted from the job managing information.

### DETAILED DESCRIPTION

Exemplary embodiments according to the present invention will be described in detail with reference to the accompanying drawings.

### <System Configuration>

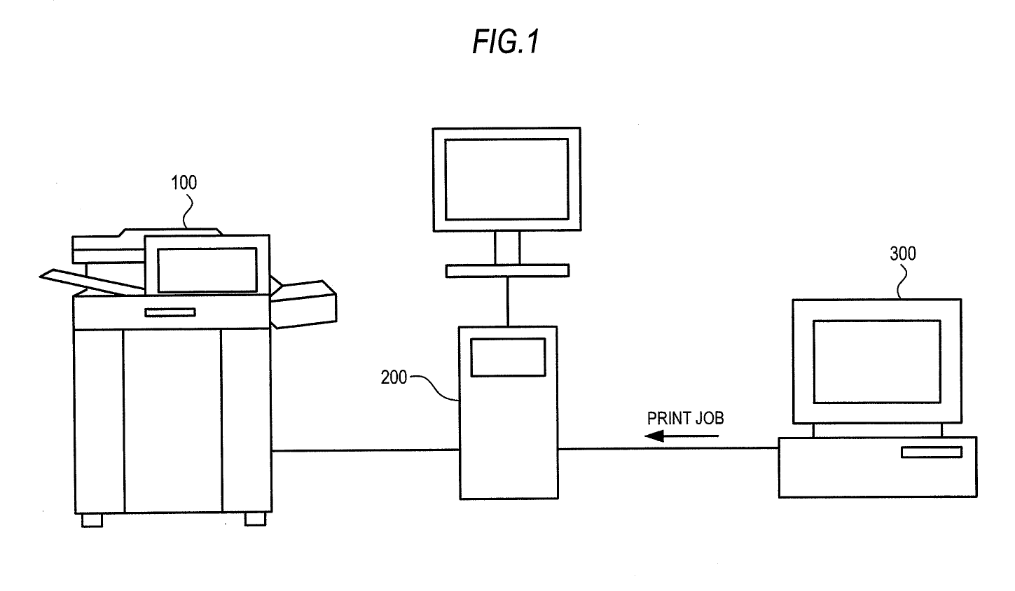

FIG. 1 is a diagram showing the overall configuration of an image forming system according to a first exemplary embodiment.

The image forming system shown in FIG. 1 includes an image forming apparatus 100, a print server 200 and a client terminal 300 that are connected to one another through a network or the like so that signals can be transmitted/received among them. In the configuration shown in FIG. 1, a print job (print command) is issued from the client terminal 300 and transmitted to the print server 200. Under the control of the print server 200, the print job is executed by the image forming apparatus 100. The print job issued from the client terminal 300 contains image data as a print target and a control command in which settings in the print processing are described. The image data is described by using PDL (Page Description Language), for example, and the control command is described by using each kind of job control language. The configuration shown in FIG. 1 is merely an example of the system configuration for implementing this exemplary embodiment. In the actual system, the image forming apparatus 100 or the client terminal 300 may be configured to have the function of the print server 200.

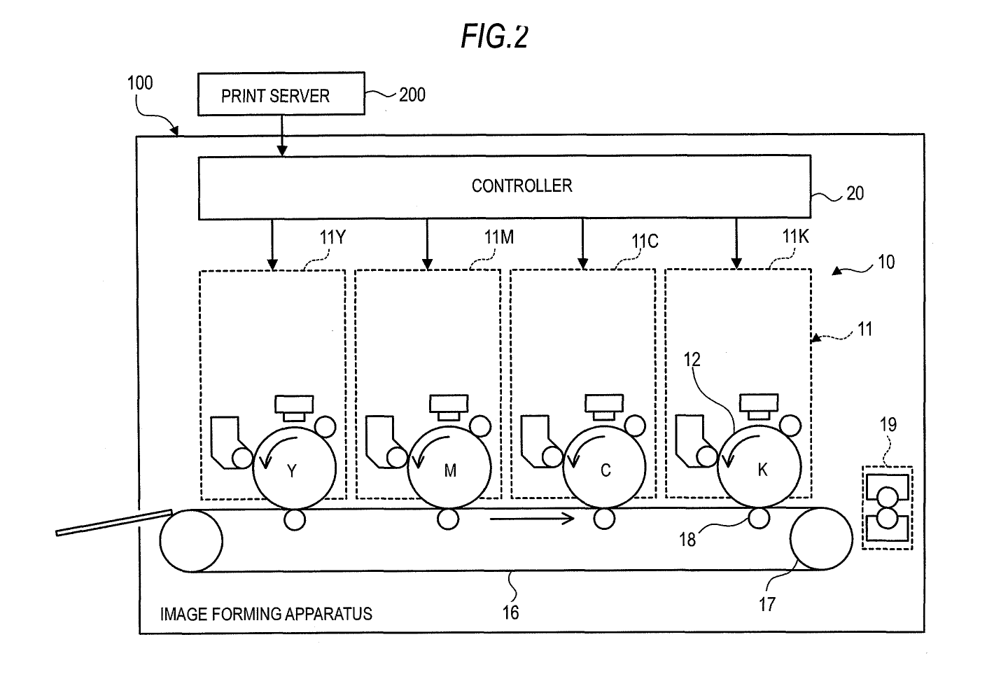

FIG. 2 is a diagram showing an example of the configuration of the image forming apparatus 100.

The image forming apparatus 100 shown in FIG. 2 has an image forming section 10 for forming an image in accordance with image data of each color in image forming material (for example toner), and a controller 20 for controlling the overall operation of the image forming apparatus. Furthermore, the image forming apparatus 100 also includes a display as a display device for displaying a preview image and various kinds of information, an operation unit for accepting a user's operation, a secondary memory such as a magnetic disk device or the like, etc. (not shown). The image forming apparatus 100 creates an image as a print target on the basis of a print job, prints a medium such as a sheet, and discharges the printed medium.

The image forming section 10 is an image forming unit having four image forming units 11 (11Y, 11M, 11C, 11K for respective colors) in correspondence with the respective colors of yellow (Y), magenta (M), cyan (C) and black (K). Furthermore, the image forming section 10 includes a transporting belt 16 for transporting paper (print medium) as a target onto which toner images of the respective colors formed on respective photoconductor drums 12 of the respective image forming units 11 are transferred and multiplexed, a driving roll 17 for driving the transporting belt 16, a transfer roll for transferring the toner image formed on each photoconductor drum 12 onto paper (sheet), and a fixing unit 19 for heating and pressurizing a non-fixed toner image of the paper after the transfer. In this exemplary embodiment, the printing system of the image forming section 10 is not limited to a specific one. That is, the printing system of the image forming section 10 of this exemplary embodiment is not limited to an electrophotographic system shown in FIG. 1, but the image forming apparatus 10 of this exemplary embodiment may be constructed by each of printing units adopting various printing systems such as an ink jetting system, a thermal system, etc.

The controller 20 is implemented by CPU, ROM for storing programs executed by CPU, RAM as a working memory, etc. The controller 20 controls the operation of the image forming section 10 and also controls various operations on the basis of pre-installed programs and various kinds of settings. Furthermore, the controller 20 accepts a print job from the print server 200, generates an image as a print target and executes various kinds of image processing such as change, correction, etc. of image size and layout.

The print server 200 and the client terminal 300 are implemented by a computer such as a personal computer or the like, for example.

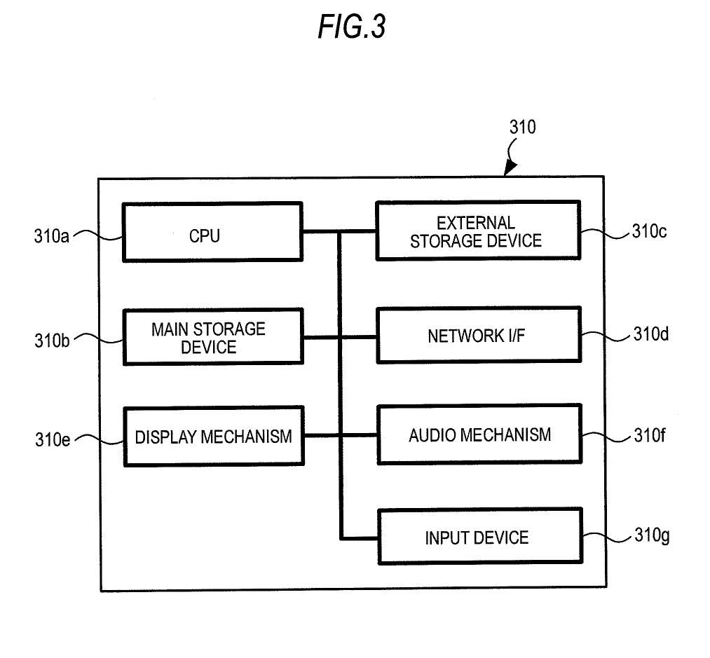

FIG. 3 is a diagram showing an example of the hardware configuration of the computer which implements the print server 200 and the client terminal 300.

The computer 310 shown in FIG. 3 has CPU (Central Processing Unit) 310a as a computing unit, a main storage device (main memory) 310b as a memory, and an external storage device (external memory) 310c. A magnetic disk device (HDD: Hard Disk Drive), SSD (Solid State Drive) or the like is generally used as the external storage device 310c. Furthermore, the computer 310 shown in FIG. 3 has a network I/F (interface) 310d which is connected to an external device through a network, a display mechanism 310e for performing a display on a display device, and an audio mechanism 310f for outputting sounds. A chip set and a bridge circuit (not shown) are interposed between CPU 310a and the other constituent elements.

In FIG. 3, the respective constituent elements are connected to one another through various kinds of buses such as a system bus, an input/output bus, etc. For example, CPU 310a and the main storage device 310b are connected to each other through the system bus and the memory bus. CPU 310a is connected to the external storage device 310c, the network I/F 310d, the display mechanism 310e, the audio mechanism 310f, an input device 310g, etc. through input/output buses such as PCI (Peripheral Components Interconnect), PCI Express, serial ATA (AT Attachment), USB (Universal Serial Bus), AGP (Accelerated Graphics Port), etc.

FIG. 3 merely shows the hardware configuration of the computer that implements the print server 200 and the client terminal 300, and thus this exemplary embodiment is not limited to the configuration shown in FIG. 3. For example, in place of the external storage device 310c, a drive using a flexible disk or an optical disk may be provided or a USB memory may be provided. The USB memory is connected to a bridge circuit through USB. The audio mechanism 310f may be configured so that it is not designed as an independent body, but it is provided as a function of a chip set.

### <Functional Configuration of Print Server 200>

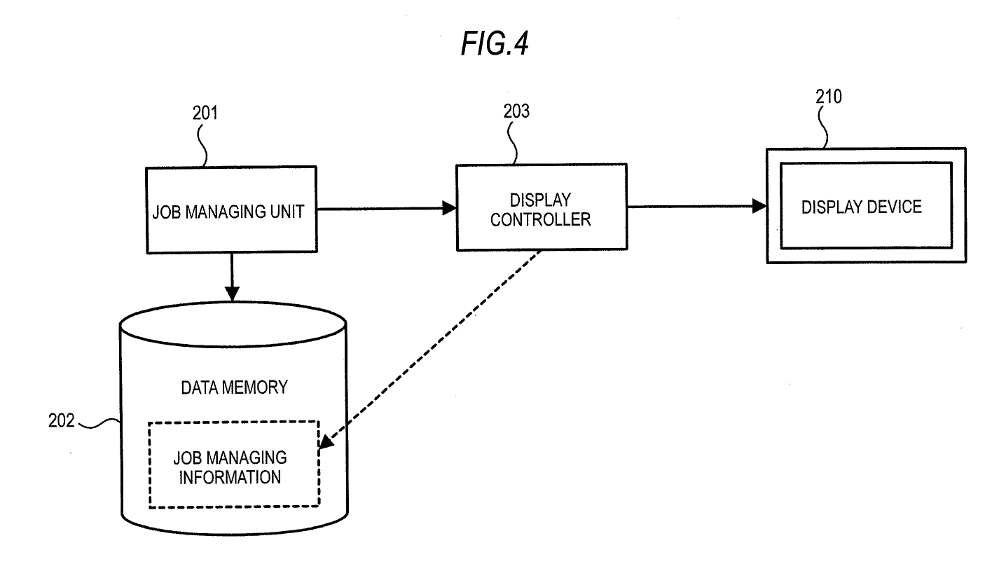

FIG. 4 is a diagram showing an example of the functional configuration of the print server 200.

Referring to FIG. 4, the print server 200 has a job managing unit 201, a data memory 202 and a display controller 203. The print server 200 has a display device 210 for displaying a status report described later under the control of the display controller 203. In the configuration shown in FIG. 4, the job managing unit 201 and the display controller 203 are implemented by executing programs stored in the main storage device 310b by CPU 310a of the computer 310 shown in FIG. 3, for example. The data memory 202 is implemented by the main storage device 310b or the external storage device 310c of the computer 310 shown in FIG. 3, for example. The display device 210 is constructed by LCD (liquid crystal display) or the like.

The job managing unit 201 generates managing information concerning a print job received from the client terminal 300 (hereinafter referred to as job managing information), and stores the print job into the data memory 202 to manage the print job. The job managing unit 201 successively transmits the print job to the image forming apparatus 100 on the basis of the job managing information and makes the image forming apparatus 100 execute the transmitted print job. That is, the job managing unit 201 is an example of a managing unit for managing print jobs, and also an example of an execution control unit for controlling execution of the print jobs.

When plural common print jobs contains a print condition (print setting), the job managing unit 201 links these print jobs, and makes the image forming apparatus 100 execute these print jobs as a single print job. Specifically, the job managing unit 201 registers print jobs received from the client terminal 300 as a unit called as “link job” into the job managing information and manages these print jobs. The link job is a virtually set job so that the print jobs are packaged and handled. The job managing unit 201 registers plural print jobs having the same print condition as print jobs constituting the same link job into the job managing information. Accordingly, there is a case where the link job is constructed by one print job or a case where the link job is constructed by plural print jobs. This link job is handed as an execution unit by the image forming apparatus 100. That is, the execution of print jobs in the image forming apparatus 100 is executed on a link-job basis. In other words, the image forming apparatus 100 executes the image forming processing while handling a link job (linked print jobs) as a single print job. Accordingly, the start-up processing and the stop processing are executed every time one link job is executed, and a print condition identified when print jobs are linked is obtained from a control command contained in the print jobs, for example.

The display controller 203 generates a status report for reporting an execution status of a print job on the basis of job managing information generated by the job managing unit 201, and displays the status report on the display device 210. The execution status of each print job issued from the client terminal 300 is displayed on the status report. As described above, there is a case where plural print jobs are converted to one (single) link job by the job managing unit 201. This conversion is executed in the internal processing of the print server 200, and thus this does not reflect the status report. That is, each print job issued from the client terminal 300 is individually described and the execution status thereof is displayed in the status report irrespective of whether print jobs are converted to a link job or not.

### <Example of Configuration of Job Managing Information and Status Report>

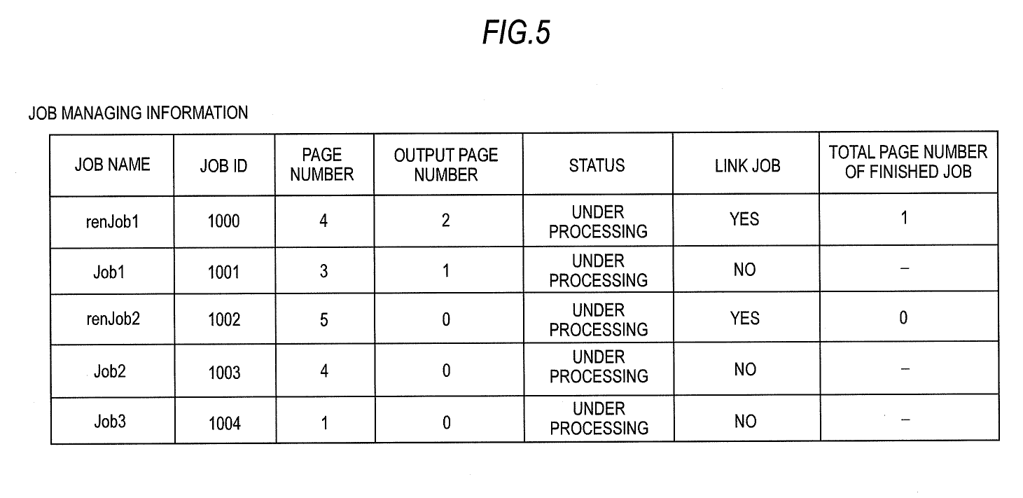

FIG. 5 is a diagram showing an example of the construction of the job managing information used in this exemplary embodiment.

Managing items such as “job name”, “job ID”, “page number”, “output page number”, “status”, “link job” and “total page number of finished jobs” are set in the job managing information shown in FIG. 5.

The item “job name” represents the name of a print job transmitted from the client terminal 300. The link job is created by the job managing unit 201 of the print server 200, and thus the job managing unit 201 provides the link job. In the example of FIG. 5, the name “renJob” and the name “job” are provided to the link job and the print job, respectively.

The item “Job ID” is managing information which is uniquely allocated when each job (link jobs and print jobs) is registered in the job managing information. In the example of FIG. 5, serial numbers are allocated to link jobs and print jobs while they are not discriminated from each other.

The item “page number” represents the number of pages of each job. In the case of a link job, the item “page number” represents the total number of pages of respective print jobs constituting the link job.

The item “output page number” represents the number of pages on which the processing has been executed. When “output page number” is equal to “page number”, it is determined that the job is finished.

The item “status” represents the status of each job. At the time point when a job is registered in the job managing information, “status” is set to “under processing”. When a cancel instruction is accepted, “status” is set to “during cancel”. However, there is no state of “finish”, and when execution of a job is finished, the job is deleted from the job managing information.

The item “link job” is identification information representing a discrimination between “link job” or “print job”. The item “total page number of finished jobs” represents the total number of pages of processing-completed print jobs out of the print jobs contained in a link job.

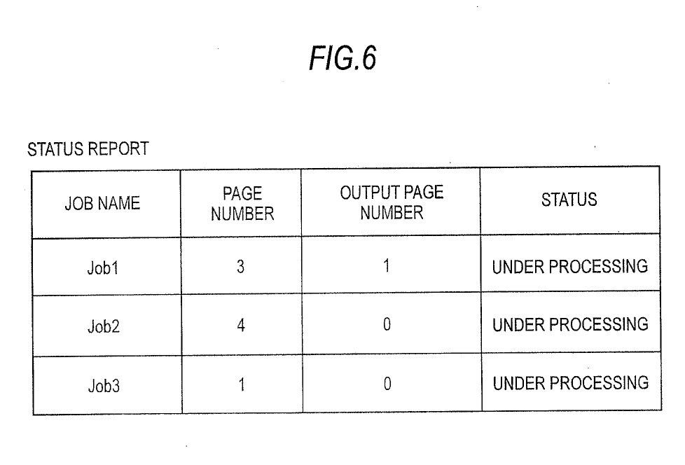

FIG. 6 is a diagram showing an example of the configuration of a status report created on the basis of the job managing information of FIG. 5.

The status report shown in FIG. 6 is created on the basis of information obtained from the job managing information, and “job name”, “page number”, “output page number” and “status” are set as described items in the status report. The contents of the respective items are the same as the contents of the corresponding items of the job management information shown in FIG. 5. The link job of the job managing information is a virtual job used in the internal processing of the print server 200, and thus it is not described in the status report. In the example of FIG. 6, only the substantive print jobs “job1”, “job2” and “job3” out of the jobs registered in the job managing information of FIG. 5 are described in the status report.

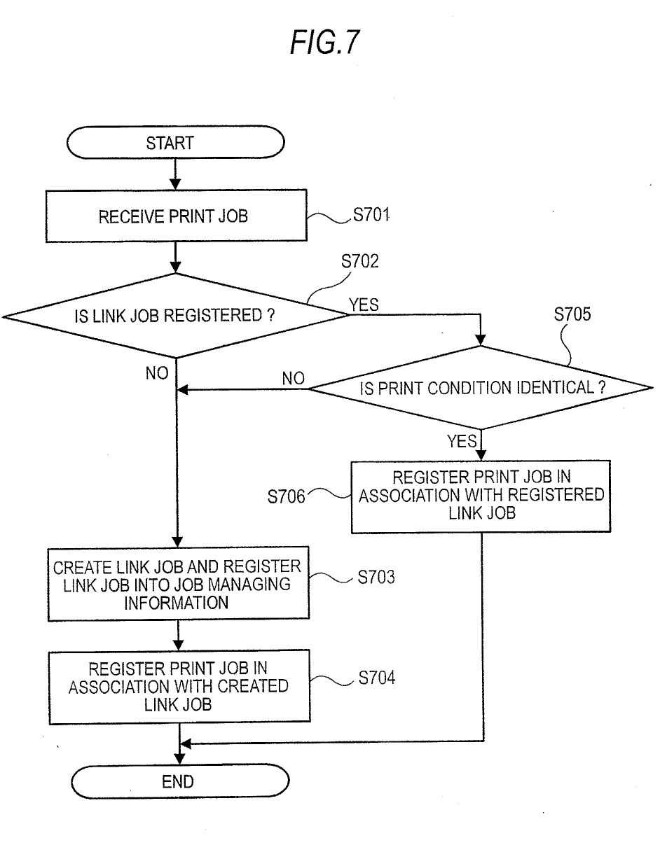

FIG. 7 is a flowchart showing the procedure of generating the job managing information by the job managing unit 201 of the print server 200.

As shown in FIG. 7, when receiving a new print job from the client terminal 300 (step 701), the job managing unit 201 checks whether a link job (print job) is registered in the job managing information (step 702). When no link job is registered in the job managing information, the job managing unit 201 creates a link job and registers it into the job managing information (step 703), and registers the received print job as a print job constituting the created link job (in association with the created job) into the job managing information (step 704).

On the other hand, in step 702, when one or more link jobs are registered in the job managing information, the job managing unit 201 determines whether the print condition of the last link job out of the link jobs registered in the job managing information is identical to the print condition of the received print job (step 705). When these print conditions are identical to each other, the received print job is received as a print job constituting the last link job (in association with the last job) into the job managing information (step 706). Accordingly, the received print job is linked to the other print jobs constituting the last link job.

IN step 705, when the print condition of the last link job out of the link jobs registered in the job managing information is not identical to the print condition of the received print job, the job managing unit 201 creates a link job and registers the link job into the job managing information (step 703), and also registers the received print job as a print job constituting the created link job (in association with the created job) into the job managing information (step 704).

### <Job Managing Information and Update Processing of Status Report>

Next, the update processing of the job managing information and the status report in connection with execution of a print job (link job) will be described.

The job managing unit 201 successively transmits the jobs (link jobs and print jobs) registered in the job managing information as described above to the image forming apparatus 100 from the head job on a link-job basis, and makes the image forming apparatus 100 execute the transmitted job. Even during execution of a link job in the image forming apparatus 100, when the job managing unit 201 receives a new print job, the job managing unit 201 registers the received print job into the job managing information according to the procedure described with reference to FIG. 7.

The image forming apparatus 100 transmits a notification indicating output completion of output pages to the job managing unit 201. On the basis of the information from the image forming apparatus 100, the job managing unit 201 updates the corresponding link job of the job managing information and the number of output pages in an entry of the head print job belonging to the link job. When the value of the output page number is equal to the value of the page number of the head print job belonging to the link job, it means that the processing of the print job is completed. Accordingly, the value of the total page number of the finished jobs in the entry of the link job is incremented by one, and the entry of the head print job for which the processing is completed is deleted.

Here, it is considered that the print server 200 receives a cancel command of the print job belonging to a link job while the link job is being executed in the image forming apparatus 100. When the print job as a cancel target has been already executed, it is needless to say that the execution of the print job is not ceased.

On the other hand, when the print job as a cancel target has not yet been executed, execution of the print job is canceled. In this exemplary embodiment, a print job is executed on a link-job basis, and thus cancellation of some print job affects execution of other print jobs which belong to the same link job and have not yet been executed. Specifically, when execution of some print job is cancelled, execution of other print jobs which belong to the same link job and are registered after the canceled print job (that is, which are going to be executed after the cancelled print job) is canceled. However, plural print jobs constituting a link job are print jobs which are originally individually issued, and thus even when execution of some of the print jobs is canceled, the other print jobs must be executed.

Therefore, in order to execute non-executed print jobs (hereinafter referred to as “non-executed job”) which belong to the same link job as the cancel target print job and registered after the cancel target print job (hereinafter referred to as “target job”), the job managing unit 201 itself re-issues a print job as a non-executed job. Specifically, the job managing unit 201 transmits a print job while setting the job managing unit 201 as a transmission destination. At this time, in order to discriminate the print job re-issued by the job managing unit 201 itself from a normal print job issued by the client terminal 300, the re-issued print job is transmitted with being added with a job ID in the job managing information. On the basis of whether the received print job is added with a job ID or not, the job managing unit 201 identifies whether the print job is the print job re-issued by the job managing unit 201 itself.

Furthermore, in this exemplary embodiment, with respect to the job managing information, in order to discriminate re-issued print jobs and a link job containing the re-issued print jobs from other normal print jobs and a link job containing the normal print jobs, two statuses of “wait for restart” and “under processing (2)” are newly introduced in the status.

“Wait for restart” is used for the entry of a link job in the job managing information. This status represents a waiting state for restart of execution of non-executed jobs when some of print jobs belonging to a link job are canceled and non-executed jobs which are not canceled exist. When the execution of the non-executed jobs is restarted, the status of the link job is shifted from “wait for restart” to “under processing”.

“Under processing (2)” is used for the entry of a print job in the job managing information. This status represents a waiting state for restart of execution based on re-issue of a print job when other print jobs belonging to the same link job are canceled. When execution of a print job is restarted, the status of the print job is shifted from “under processing (2)” to “under processing”. This status “under processing (2)” is used in the status report.

When receiving a print job having a job ID as described above, the job managing unit 201 of this exemplary embodiment does not newly register the received print job in the job managing information, but registers the received print job by overwriting the received print job on the entry of the corresponding non-executed job whose status is “under processing (2)”. On the basis of the re-registered print job, execution of the link job containing this print job is restarted.

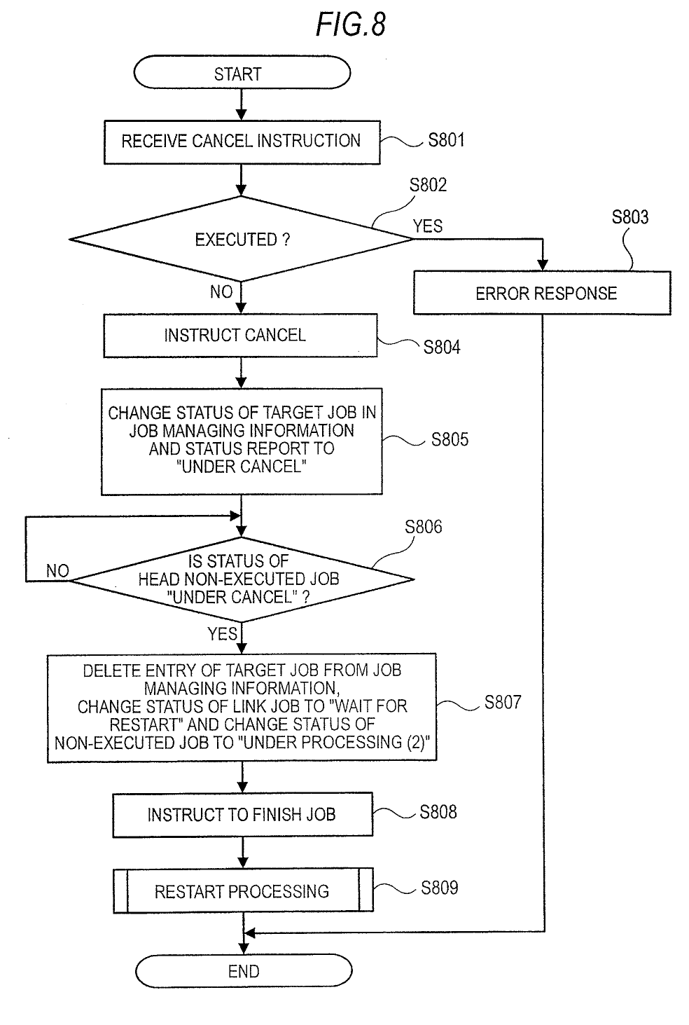

FIG. 8 is a flowchart showing the operation of the job managing unit 201 and the display controller 203 when the cancel command of a print job is received.

As shown in FIG. 8, when receiving the cancel command of a print job (step 801), the job managing unit 201 first checks whether a target job (cancel target print job) has been executed or not (step 802). When the target job has been executed, a notification indicating that the target job cannot be cancelled (error response) is returned to the client terminal 300 (step 803), and then the job managing unit 201 returns to the processing of the normal execution control.

When the target job has not yet been executed, the job managing unit 201 executes a cancel instruction of the target job to the image forming apparatus 100 (step 804). At this time, when a non-executed job (a print job which belongs to the same link job as the target job and registered after the target job) exists, the cancel instruction is also executed on the non-executed job. The job managing unit 201 sets the status of the target job in the job managing information to “during cancel”. In connection with this operation, the display controller 203 sets the status of the target job in the status report to “during cancel” (step 805).

When the execution of print jobs progresses and the canceled print job (target job) is set to the head of the link job (step 806), the job managing unit 201 deletes the entry of the target job from the job managing information. Accordingly, the print jobs contained in the link job to which the target job belongs include only non-executed jobs. Furthermore, the status of the link job is set to “wait for restart”, and the status of the non-executed job is set to “under processing (2)” (step 807). The job managing unit 201 instructs the image forming apparatus 100 to finish the execution of jobs (step 808), and in response to this instruction, the image forming apparatus 100 executes the stop processing. Accordingly, the execution of the link job is finished, and thus all of the page number, the output page number and the total page number of the finished jobs are set to “0” in the entry of the link job in the job managing information. The entries of the link jobs and the non-executed jobs are not deleted from the job managing information. Thereafter, the job managing unit 201 executes the restart processing to execute the non-executed jobs (step 809).

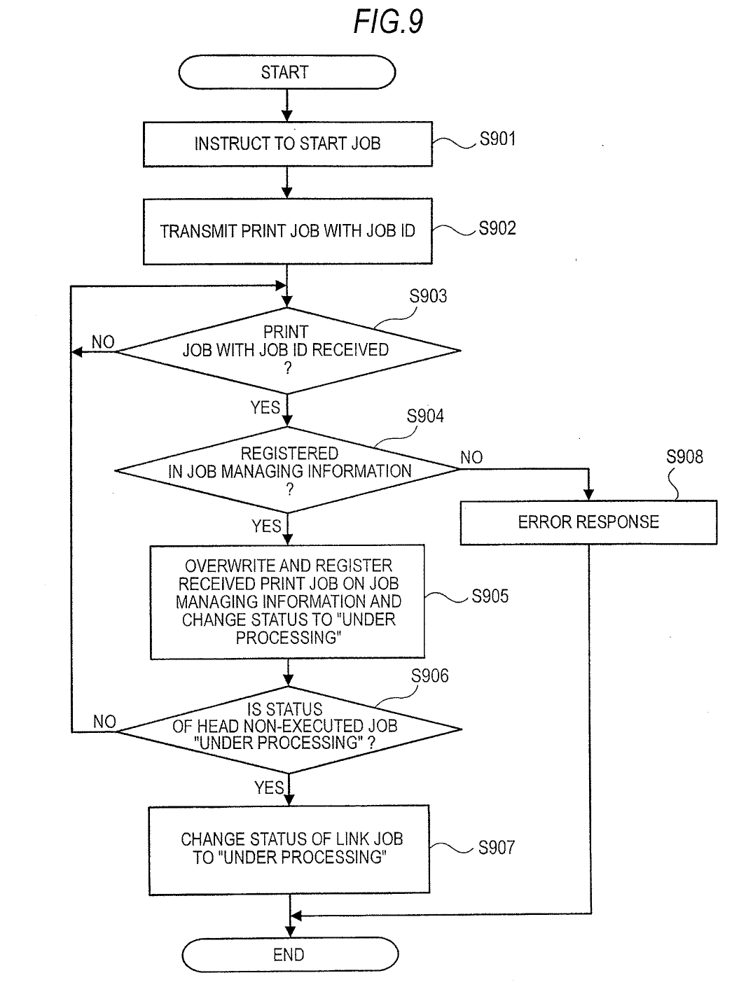

FIG. 9 is a flowchart showing the content of the restart processing of the step 809 of FIG. 8.

The job managing unit 201 first executes a job starting instruction (step 901). In response to this instruction, the image forming apparatus 100 executes the start-up processing. Furthermore, the job managing unit 201 transmits a print job added with a job ID with respect to the non-executed jobs while setting the print server 200 as a transmission destination (step 902). When a fixed time which is preset to receive the print job added with the job ID elapses after transmission of the print job with the job ID in step 902, the job managing unit 201 deletes the entry in which the status of the job managing information is set to “under processing (2)”.

Subsequently, when receiving the print job with the job ID within the fixed time described above (step 903), the job managing unit 201 checks whether the received print job with the job ID is registered in the job managing information (step 904). When the received print job with the job ID is registered in the job managing information, the job managing unit 201 overwrites the print job with the job ID on the job managing information to register the print job, and changes the status to “under processing” (step 905).

Subsequently, with respect to a link job in which the status in the job managing information is set to “wait for restart”, the job managing unit 201 determines whether the status of the non-executed job at the head of the non-executed jobs belonging to the link job is set to “under processing” or not (step 906). When the status of the head non-executed job in the link job is not set to “under processing” (that is, in the case of “under processing (2)”), the job managing unit 201 returns to the step 903 to wait for reception of a print job with a job ID until the fixed time elapses.

When the status of the head non-executed job in the link job is set to “under processing”, the job managing unit 201 changes the status of the job managing information of the link job to “under processing” (step 907). Accordingly, the execution of this link job by the image forming apparatus 100 is restarted. The status of the head non-executed job of the link job is set to “under processing” in the following cases. That is, the print job added with the job ID corresponding to the head non-executed job is received. Furthermore, the entry of the non-executed job in which the status in the job managing information is set to “under processing (2) ” is deleted because the fixed time elapses from the transmission of the print job added with the job ID in step 902, so that a non-executed job whose print job with the job ID is received is set to the head print job.

Here, there is a case where a print job with a job ID is received, however, the received print job with the job ID is not registered in the job managing information (“No” in step 904). For example, there is a case where after the entry of a non-executed job in which the statue in the job managing information is set to “under processing (2) ” is deleted because the fixed time elapses from transmission of a print job with a job ID in step 902, the print job with the job ID corresponding to the deleted entry is received. In this case, the job managing unit 201 transmits to the client terminal 300 a notification indicating that the received print job with the job ID cannot be executed (error response), and then finishes the processing (step 908). When the print job with the job ID cannot be overwritten and registered in the job managing information, a new job ID may be newly provided so that the print job is executed as a normal print job without error-finishing the processing as described above.

### <Specific Example of Update of Job Managing Information and Status Report>

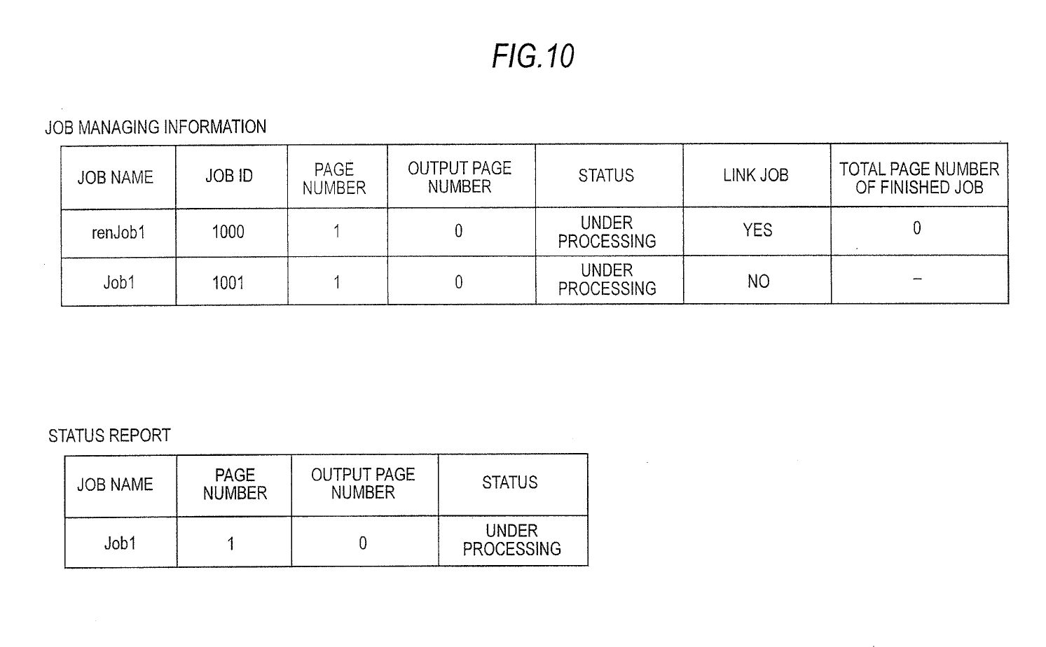

The updating operation of the job managing information and the status report will be further described with reference to FIGS. 10 to 21.

First, it is assumed that the print server 200 receives a print job “Job1” from the client terminal 300 after the job managing information and the status report are initialized. At this time, the job managing unit 201 generates a link job “renJob1”, and registers “renJob1” and “Job1” into the job managing information. On the basis of this job managing information, the information of “Job1” is displayed in the status report. FIG. 10 shows the statuses of the job managing information and the status report at this time. As shown in FIG. 10, “renJob1” and “Job1” are registered in the job managing information, and “Job1” is displayed in the status report. At this time point, the print jobs belonging to “renJob1” contain only “Job1”, and thus the number of pages of “renJob1” is equal to the number of pages of “Job1”, that is, one page. After the job managing unit 201 registers the above data into the job managing information, the job managing unit 201 transmits the data of “Job1” as data of a first page of “renJob1” to the image forming apparatus 100, and starts execution of “renJob1”.

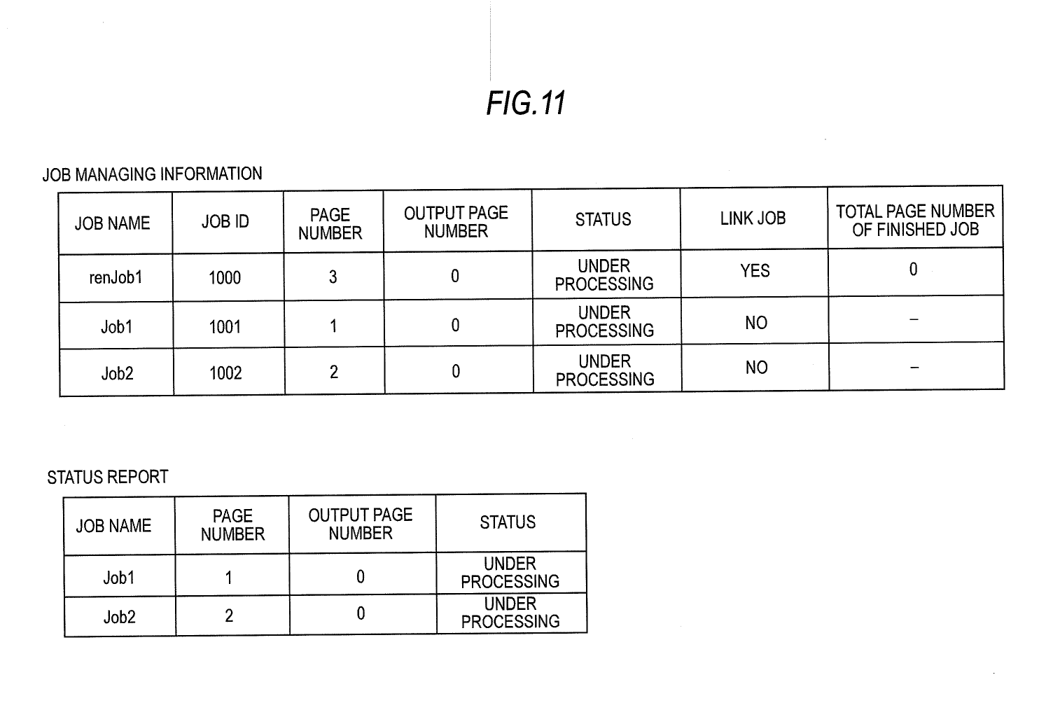

Next, it is assumed that the job managing unit 201 receives a print job “Job2” having the same print condition as “Job1”. Since “Job2” has the same print condition as “renJob1” (=“Job1”), the print job “Job2” is registered as a print job belonging to the same “renJob1” as “Job1” into the job managing information. FIG. 11 shows the statuses of the job managing information and the status report at this time. As shown in FIG. 11, “Job2” is additionally registered in the job managing information, and also additionally displayed in the status report. The page number of “renJob1” is equal to three pages by adding one page of “Job1” with two pages of “Job2”. The job managing unit 201 registers the above data into the job managing information, and then transmits the data of “Job2” as data of second and third pages of “renJob1” to the image forming apparatus 100.

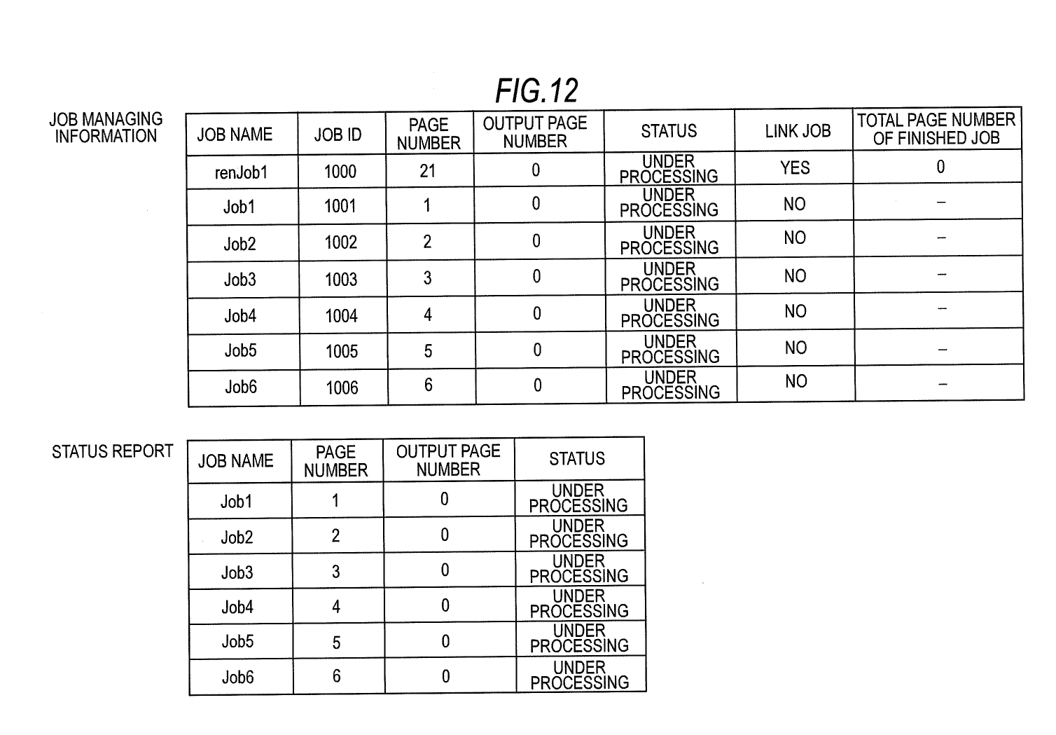

Next, it is assumed that the job managing unit 201 receives print jobs “Job3” to “Job6” having the same print condition as “renJob1”. The print jobs “Job3” to “Job6” are registered as print jobs belonging to “renJob1” into the job managing information because they have the same print condition as “renJob1”. FIG. 12 shows the statuses of the job managing information and the status report at this time. As shown in FIG. 12, “Job3” to “Job6” are additionally registered in the job managing information, and also additionally displayed in the status report. Furthermore, the page number of “renJob1” is equal to 21 pages by adding the total pages 18 of “Job3” to “Job6”. The job managing unit 201 registers the above data into the job managing information, and then transmits the data of “Job3” to “Job6” as the data of fourth to 21st pages of “renJob1” to the image forming apparatus 100.

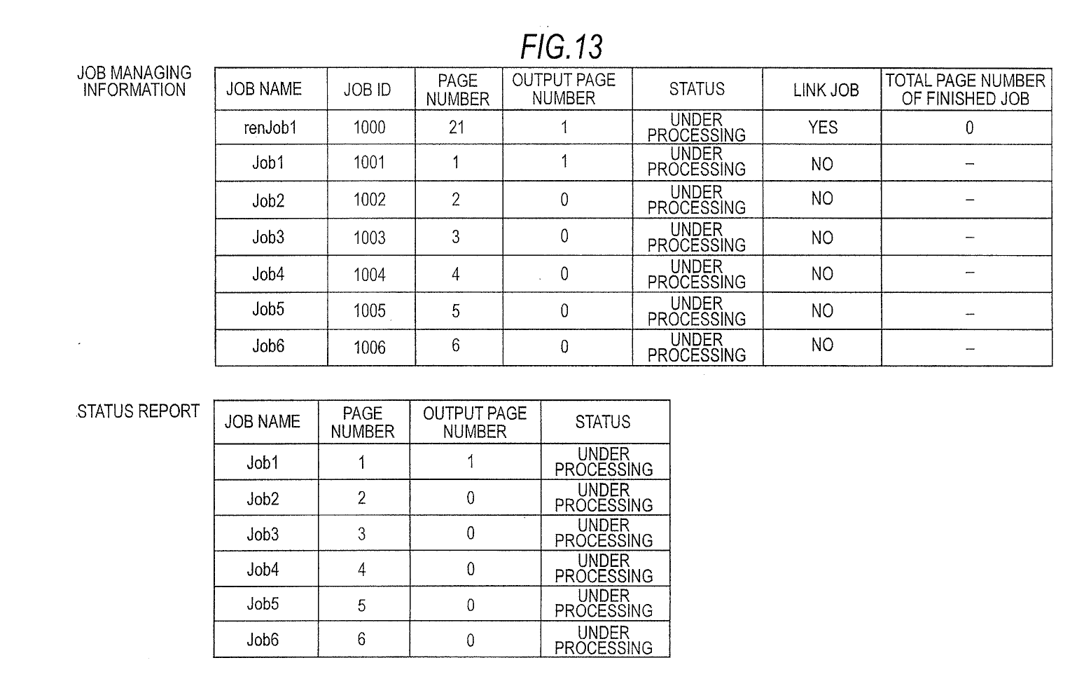

Next, it is assumed that the job managing unit 201 receives an output completion notification of the first page from the image forming apparatus 100. In response to this notification, the job managing unit 201 sets the output page numbers of “renJob1” and “Job1” of the job managing information to 1. FIG. 13 shows the statuses of the job managing information and the status report. As shown in FIG. 13, the output page numbers of “renJob1” and “Job1” in the job managing information are set to 1, and the output page number of the status report is set to 1.

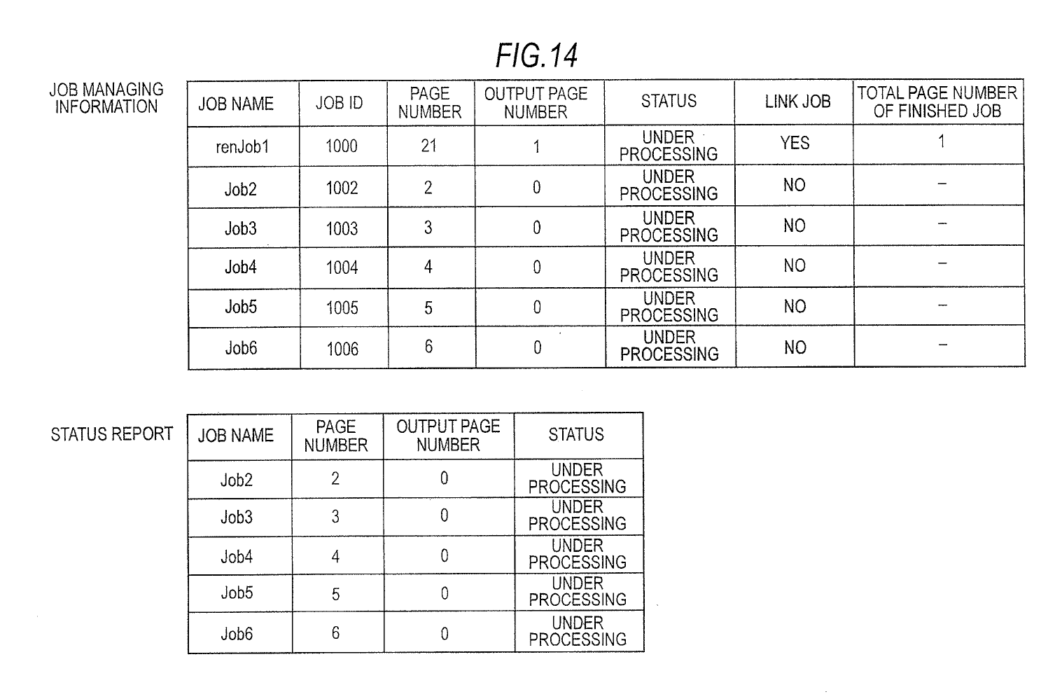

Here, the page number of “Job1” is equal to 1, and the output of the first page of “renJob1” is completed, so that the execution of “Job1” is finished. This is recognized by the fact that the page number of “Job1” is equal to the output page number (in this case, “1”). Therefore, the job managing unit 201 sets the total page number of the finished job of “renJob1” to 1 (the number of pages of the finished “Job1”), and deletes the entry of “Job1” from the job managing information. In connection with this deletion, the display controller 203 also deletes the entry of “Job1” from the status report. FIG. 14 shows the statuses of the job managing information and the status report at this time.

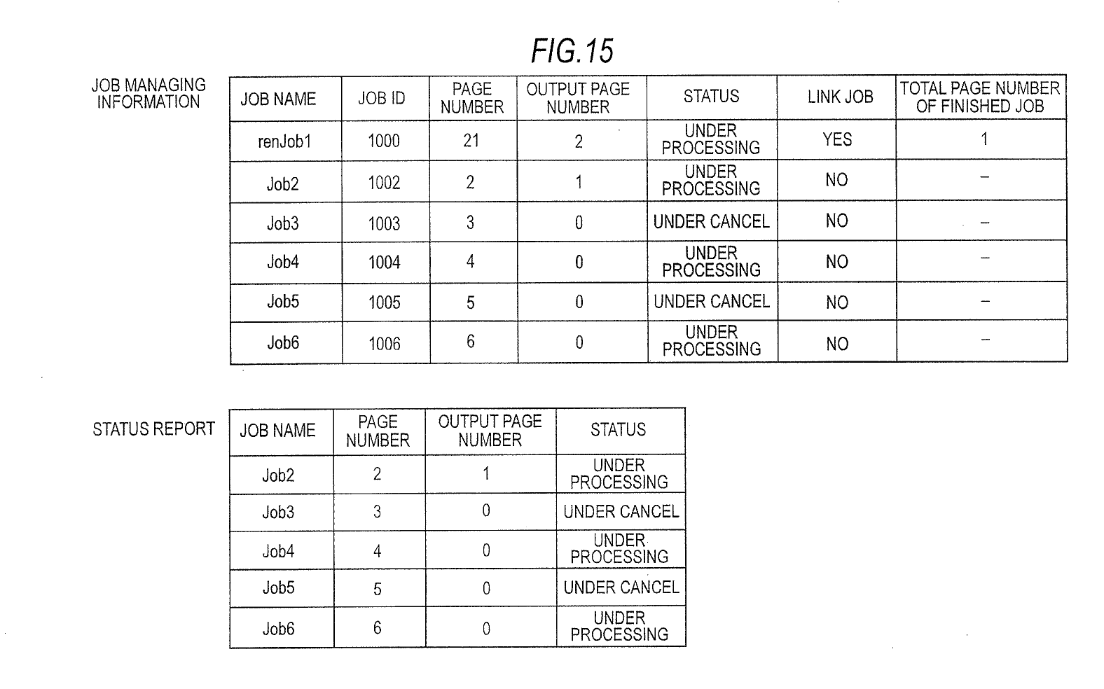

Next, it is assumed that the job managing unit 201 receives a cancel command of “Job3” and “Job5” from the client terminal 300 and also receives an output completion notification of the second page from the image forming apparatus 100. In response to this notification, the job managing unit 201 sets the output page number of “renJob1” of the job managing information to 2, and sets the output page number of “Job2” to 1. Furthermore, the job managing unit 201 changes the statuses of “Job3” and “Job5” to “under cancel”. The display controller 203 sets the output page number of “Job2” in the status report to 1, and changes the statuses of “Job3” and “Job5” to “under cancel”. FIG. 15 shows the statuses of the job managing information and the status report at this time. The job managing unit 201 updates the job managing information, and then executes a cancel instruction of the output processing of the fourth and subsequent pages of “renJob1” corresponding to the print jobs subsequent to “Job3”.

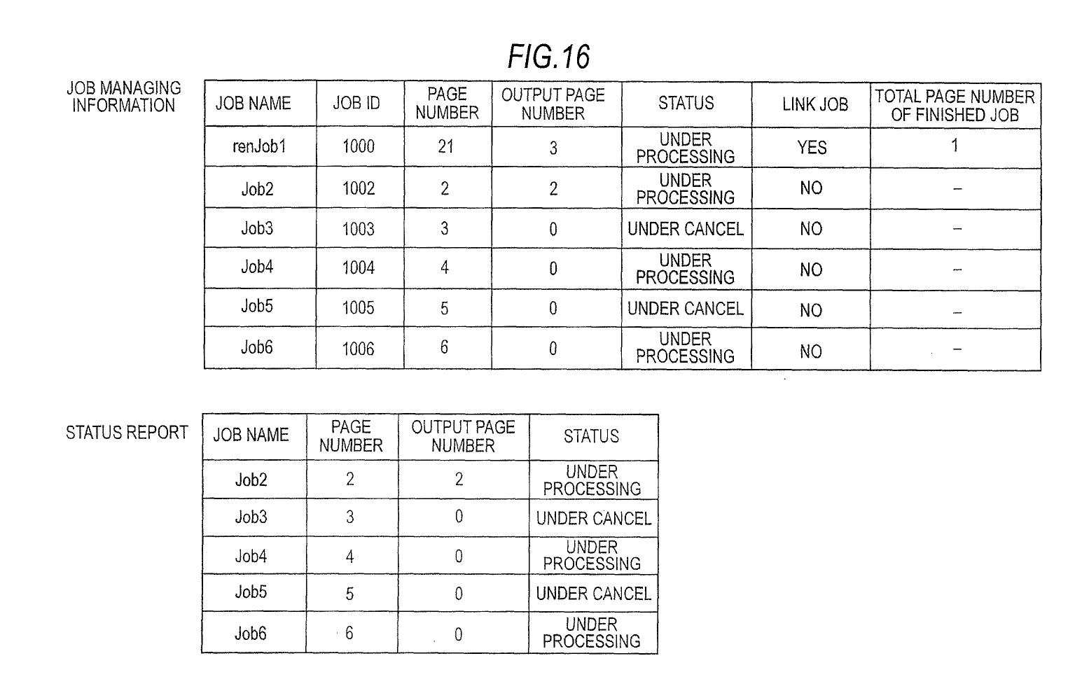

Next, it is assumed that the job managing unit 201 receives an output completion notification of the third page as the last page which is not canceled. In connection with this notification, the job managing unit 201 sets the output page number of “renJob1” of the job managing information to 3, and sets the output page number of “Job2” to 2. FIG. 16 shows the statuses of the job managing information and the status report at this time. As shown in FIG. 16, the output page number of “renJob1” in the job managing information is set to 3, the output page number of “Job2” is set to 2, and the output page number of “Job2” of the status report is set to 2.

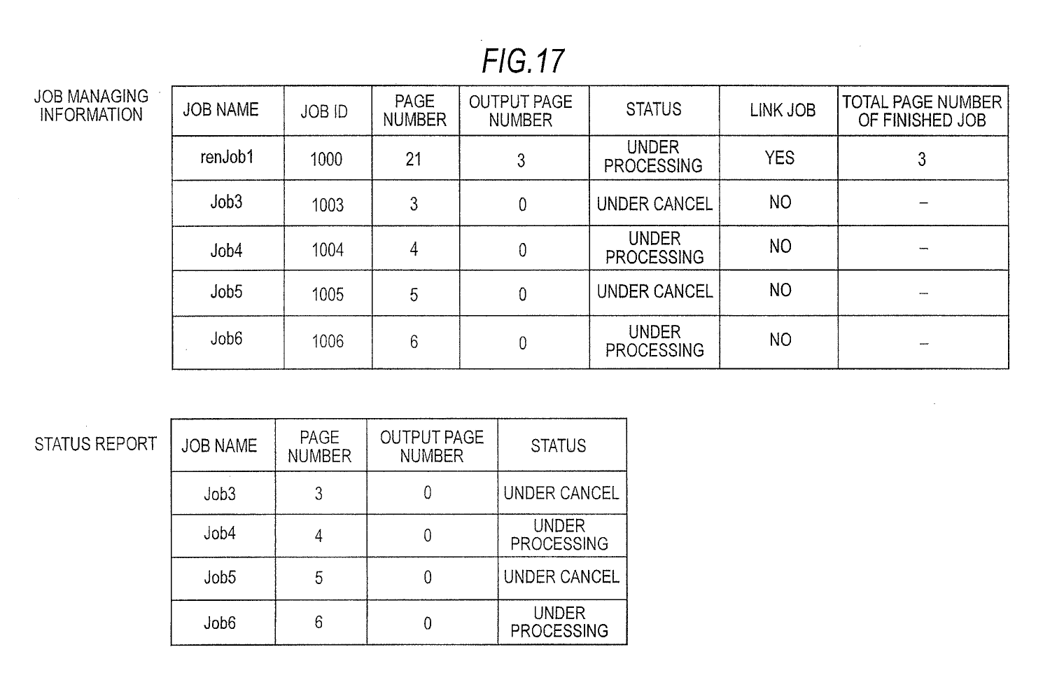

Here, since the page number of “Job2” is equal to 2, the number of pages (the value of the page number) of “Job2” is equal to the number of output pages (the value of the output page number) (in this case, “2”), and thus the execution of “Job2” is finished. Therefore, the job managing unit 201 sets the total page number of the finished jobs of “renJob1” to 3 (the page number 2 of the finished “Job2” is added to the original page number 1), and deletes the entry of “Job2” from the job managing information. In connection with this deletion, the display controller 203 also deletes the entry of “Job2” from the status report. FIG. 17 shows the statuses of the job managing information and the status report at this time.

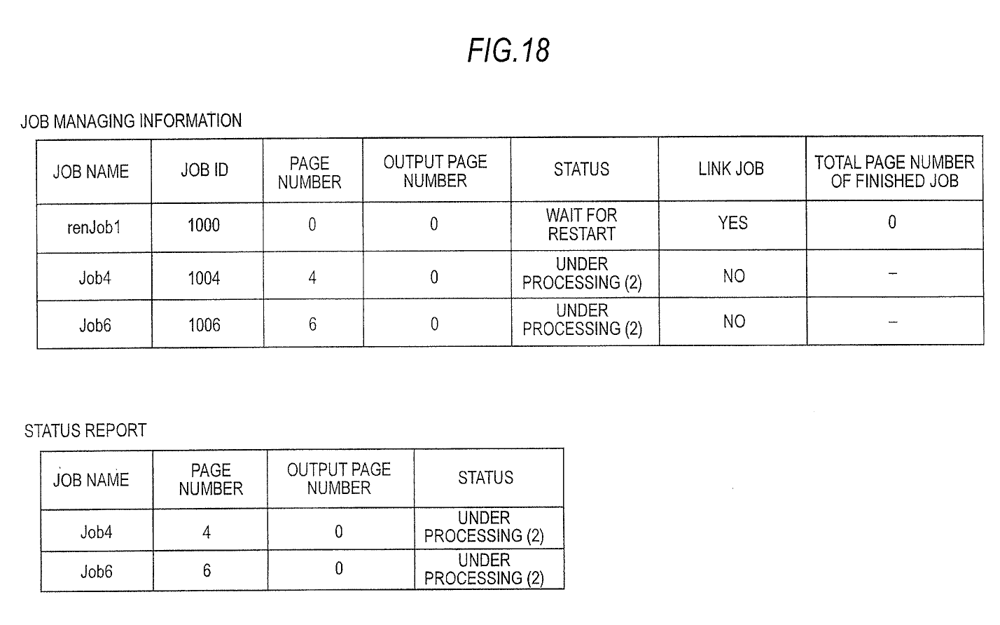

Referring to FIG. 17, in the job managing information, the status of “Job3” at the head of the print jobs belonging to “renJob1” is set to “under cancel”. Therefore, the job managing unit 201 deletes from the job managing information the entries of “Job3” and “Job5” whose statuses are “under cancel” as represented in the steps 806 and 807 of FIG. 8. Furthermore, the job managing unit 201 changes the status of “renJob 1” to “wait for restart”, and also changes the statuses of “Job4” and “Job6” to “under processing (2)”. In the status report, the entries of “Job3” and “Job5” are deleted, and the statues of “Job4” and “Job6” are changed to “under processing (2)”. Thereafter, as represented in the step 808 of FIG. 8, the execution of “renJob1” is finished. Therefore, the page number, the output page number and the total page number of the finished jobs of “renJob1” in the job managing information are equal to zero. FIG. 18 shows the statuses of the job managing information and the status report at this time. As described above, the processing of “renJob1” is temporarily finished in the job managing information. However, the entries of “Job4” and “Job6” are kept to be displayed in the status report, and the status is set to “under processing (2)”, so that a user does not have such a misunderstanding that “Job4” and “Job6” are not executed.

Subsequently, the processing is shifted to the restart processing shown in FIG. 9.

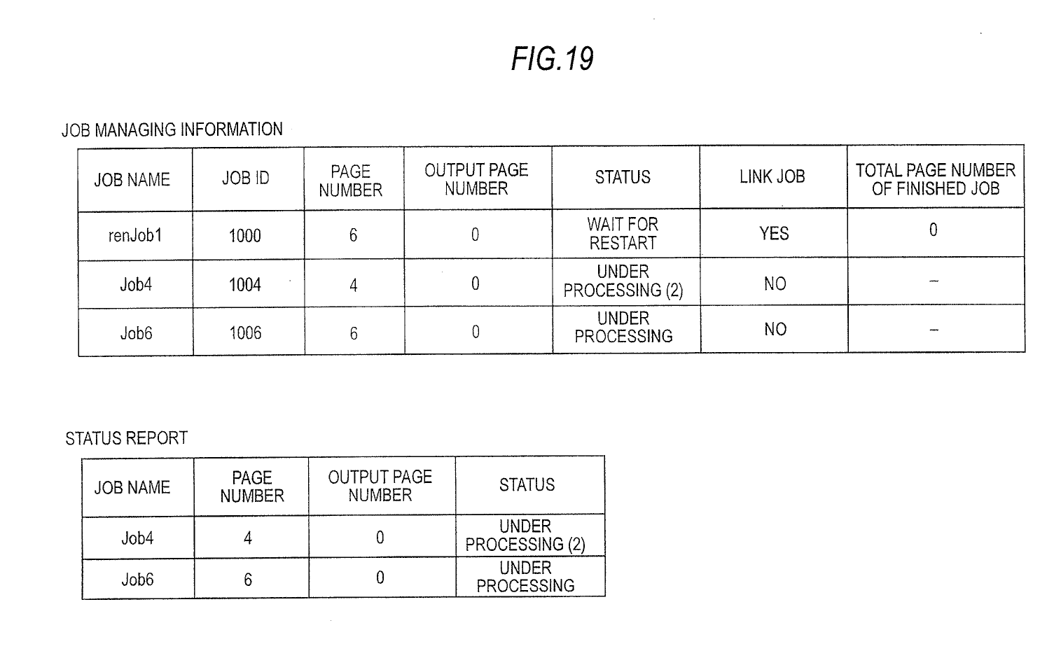

The job managing unit 201 first transmits the print job with the job ID of each of “Job4” and “Job6” to the print server 200. It is assumed that the print job with the job ID of “Job6” is received. At this time, there exists an entry of “Job6” in which the status of the job managing information is set to “under processing (2)”, and thus the job managing unit 201 overwrites and registers the received print job with the job ID on this entry, and changes the status to “under processing”. Furthermore, since “Job6” is re-registered, the page number of “renJob1” is set to “6” (the page number of “Job6”). FIG. 19 shows the statuses of the job managing information and the status report at this time. In the statuses shown in FIG. 19, the print job with the job ID of “Job4” is not received, and thus the status of the entry of “Job4” which is a head non-executed job belonging to “renJob1” is kept to “under processing (2)”. Accordingly, at this time point, execution of “renJob1” is not restarted.

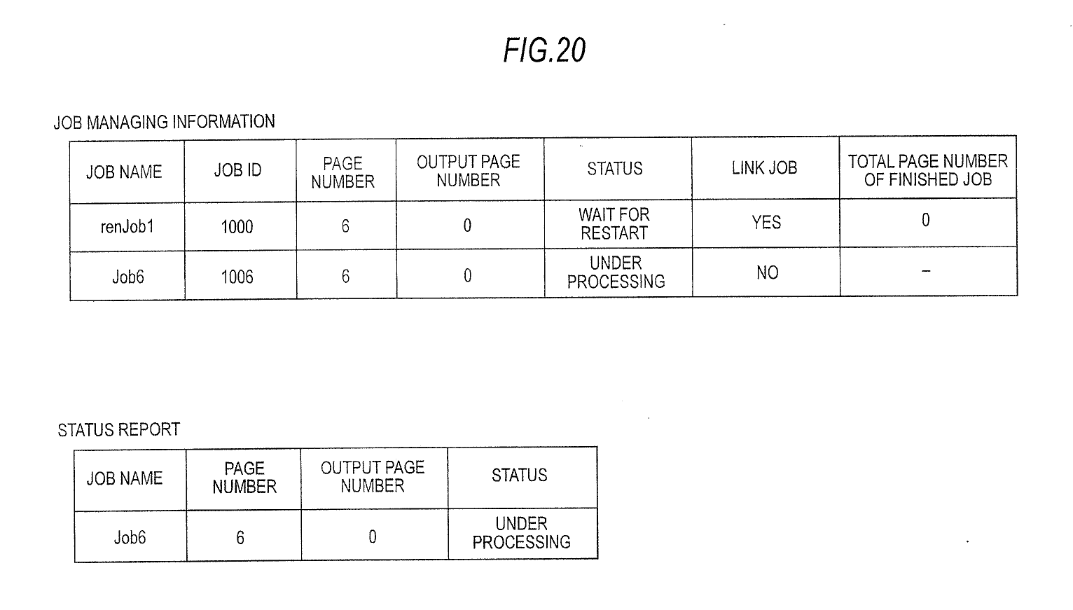

Next, it is assumed that after the job managing unit 201 transmits the print jobs with the job IDs of “Job4” and “Job6”, a fixed time set to receive the print job with the job ID elapses without receiving the print job with the job ID of “Job4”. In this case, the job managing unit 201 deletes from the job managing information the entry of “Job4” whose status is “under processing (2)”. FIG. 20 shows the statuses of the job managing information and the status report at this time.

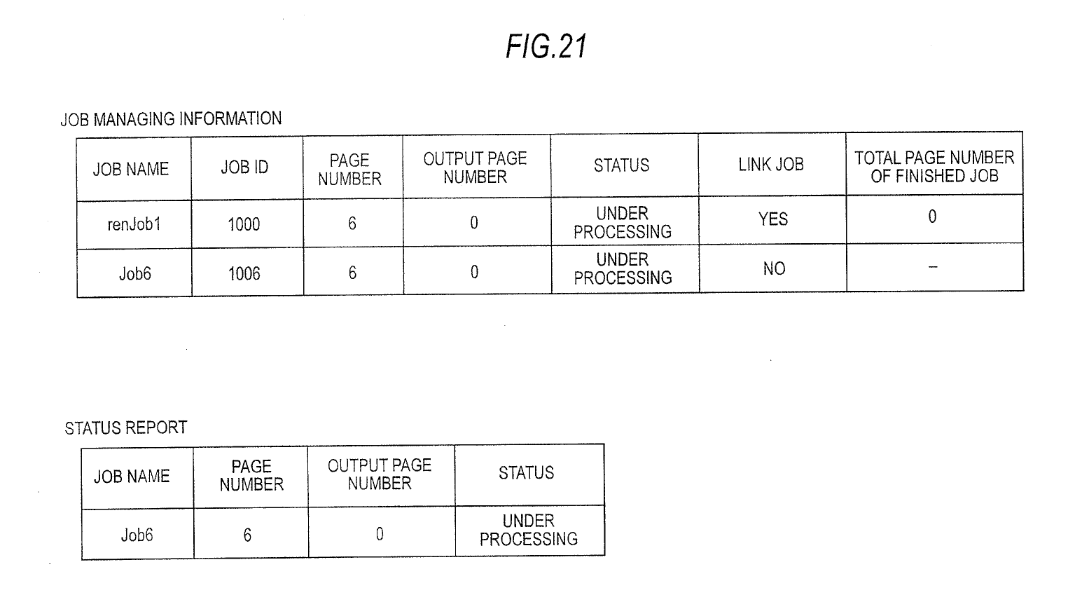

Here, the status of the head non-executed job (“Job6”) belonging to “renJob1” is set to “under processing” because the entry of “Job4” is deleted. Therefore, the job managing unit 201 changes the status of “renJob1” in the job managing information to “under processing” as represented by the steps 906 and 907 of FIG. 9. Accordingly, the execution of “renJob1” constructed by “Job6” is started. FIG. 21 shows the statuses of the job managing information and the status report at this time.

Thereafter, when the job managing unit 201 receives an output completion notification of six pages as the data of “Job6” from the image forming apparatus 100, the page number of “Job6” is equal to the output page number (in this case, “6”), and the execution of “Job6” is finished. Furthermore, the values of the page number, the output page number and the total page number of the finished jobs of “renJob1” are equal to one another (in this case, “6” because the page number is equal to the page number of “Job6”), and the execution of “renJob1” is finished. Accordingly, the job managing unit 201 deletes the entries of “renJob1” and “Job6” from the job managing information. In connection with this deletion, the display controller 203 deletes the entry of “Job6” from the status report.

Here, it is assumed that after the entry of “Job4” is deleted from the job managing information, the job managing unit 201 receives the print job with the job ID of “Job4”. However, the entry of “Job4” in the job managing information has been already deleted, and thus it cannot be overwritten and registered as a print job belonging to “renJob1”, so that the processing of “Job4” is error-finished. In this case, as described above, “Job4” may be processed as in the case of a normal print job received from the client terminal 300 without error-finishing the processing of “Job4”. That is, “renJob2” constructed by “Job4” may be generated, and “renJob2” and “Job4” may be newly registered in the job managing information to control the management and execution of “Job4”.

### Second Embodiment

As described above, according to the image forming system in which plural print jobs are executed while linked to each other, when a cancel command is issued to some of print jobs belonging to a link job, the other print jobs belonging to the same link job are cancelled together although no cancel instruction is issued to these print jobs. However, according to this exemplary embodiment, in order to execute the other print jobs as described above, the print job with the job ID issued by the print server 200 and the two statuses of “wait for restart” and “under processing (2)” in the status of the job managing information are introduced.

On the other hand, according to a second exemplary embodiment, the other print jobs belonging to the link job containing the print job to which the cancel command is issued are temporarily stored in a second queue which is prepared in addition to a queue for holding a print job to execute the print job, whereby the other print jobs can be executed. In only the status report, “under processing (2)” representing a restart waiting status is displayed in the status.

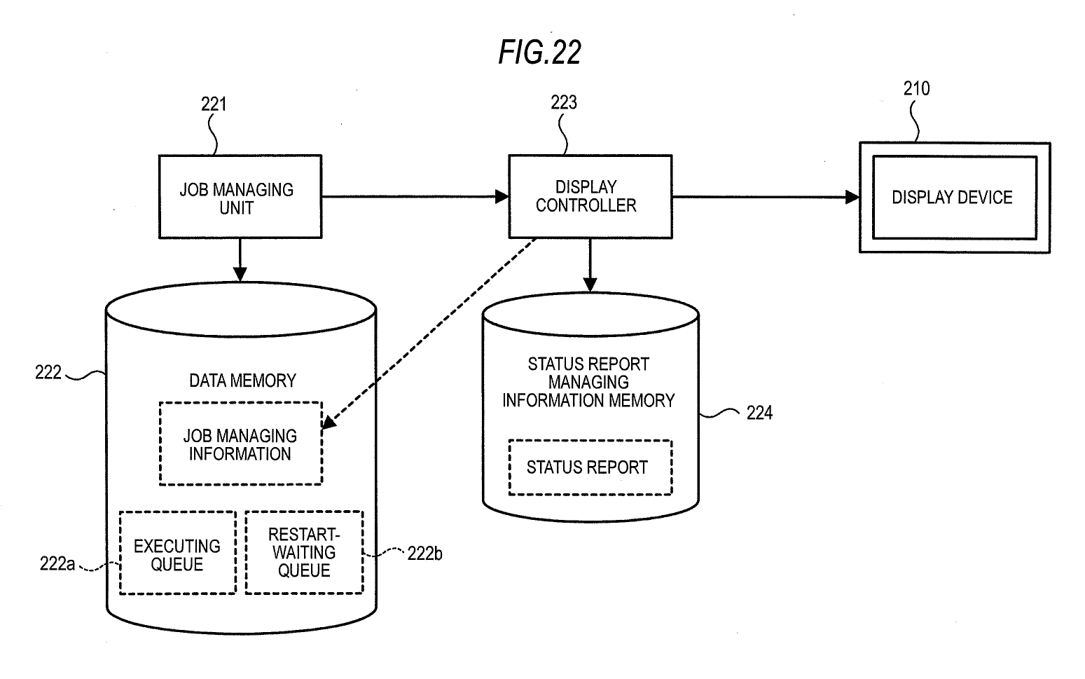

FIG. 22 is a diagram showing an example of the functional configuration of the print server 200 according to the second exemplary embodiment.

Referring to FIG. 22, the print server 200 has a job managing unit 221, a data memory 222, a display controller 223 and a status report managing information memory 224. The print server 200 has a display device 210 for displaying a status report described later under the control of the display controller 223. In the configuration shown in FIG. 22, the job managing unit 221 and the display controller 223 are implemented by executing programs read in the main storage device 310 by CPU 310a of the computer 310 shown in FIG. 3, for example. The data memory 222 and the status report managing information memory 224 are implemented by the main storage device 310b and the external storage device 310c of the computer 310 shown in FIG. 3, for example. Furthermore, the display device 210 is the same as the display 210 of the first exemplary embodiment shown in FIG. 4, and it is constructed by LCD (liquid crystal display) or the like, for example.

The job managing unit 221 generates managing information concerning a print job received from the client terminal 300 (hereinafter referred to as “job managing information”), and stores the print job into the data memory 222 to manage the print job. The job managing unit 221 successively transmits the print job to the image forming apparatus 100 on the basis of the job managing information to execute the print job. Furthermore, when there are plural print jobs having the same print condition (print setting), the job managing unit 221 links these print jobs and makes the image forming apparatus 100 execute these print jobs as a single print job. Specifically, the job managing unit 221 registers the print jobs received from the client terminal 300 as an unit called as a link job to mange these print jobs. The respective functions of the job managing unit 221 are the same as the job managing unit 201 shown in FIG. 4. Furthermore, the configuration of the job managing information is the same as the job managing information shown in FIG. 5.

The data memory 222 stores the job managing unit generated by the job managing unit 221 and the print job received from the client terminal 300. Furthermore, two kinds of queues are prepared as a print job holding unit in the data memory 222. One kind of queue is an executing queue 222a used under a normal state, and the other kind of queue is a restart waiting queue 222b used to hold other print jobs (non-executed jobs) which are canceled because a cancel command is issued to some of print jobs contained in a link job.

The display controller 223 generates a status report for notifying an execution condition of a print job to a user on the basis of the job managing information generated by the job managing unit 221, and stores the status report into the status report managing information memory 224 to manage the status report. The status report stored in the status report managing information memory 224 is displayed on the display device 210. The configuration of the status report is the same as the status report shown in FIG. 6, and the execution condition of each print job issued from the client terminal 300 is displayed. Even when the entry of a print job is deleted from the job managing information, the display controller 223 of this exemplary embodiment would not delete the entry of the print job from the status report if the print job is held in the restart waiting queue 222b of the data memory 222.

### <Update Processing of Job Managing Information and Status Report>

Next, the update processing of the job managing information and the status report in the second exemplary embodiment will be described.

The processing of accepting a print job from the client terminal 300 and updating the job managing information by the job managing unit 221 and the processing of accepting a cancel command of a print job from the client terminal 300 and changing the status of the target job (the cancel target print job based on the accepted cancel command) to “under cancel” by the job managing unit 221 are the same as the first exemplary embodiment described with reference to FIGS. 7 and 8.

When there exists a non-executed print job which belongs to the same link job as the target job, registered after the target job and has not yet been executed and to which no cancel command is issued, the job managing unit 221 of this exemplary embodiment transfers this non-executed job from the executing queue 222a to the restart waiting queue 222b. Then, the job managing unit 221 deletes the entries of the link job and all the print jobs belonging to this link job (the target job and the non-executed jobs). Thereafter, the job managing unit 221 transfers the non-executed jobs form the restart waiting queue 222b to the executing queue 222a again, registers the non-executed jobs into the job managing information and makes the image forming apparatus 100 execute the non-executed print jobs.

The display controller 223 of this exemplary embodiment temporarily stores a status report created and updated on the basis of the job managing information into the status report managing information memory 224, read out the status report from the status report managing information memory 224 and displays the status report on the display device 210. When the non-executed job is transferred to the restart waiting queue 222b by the job managing unit 221, the display controller 223 sets the status of the entry of the non-executed job in the status report to “under processing (2)” representing the restart waiting state, and stops the update of the status report. When the non-executed job is returned to the executing queue 222a by the job managing unit 221 and registered into the job managing information again, the update of the status report is restarted on the basis of the job managing information.

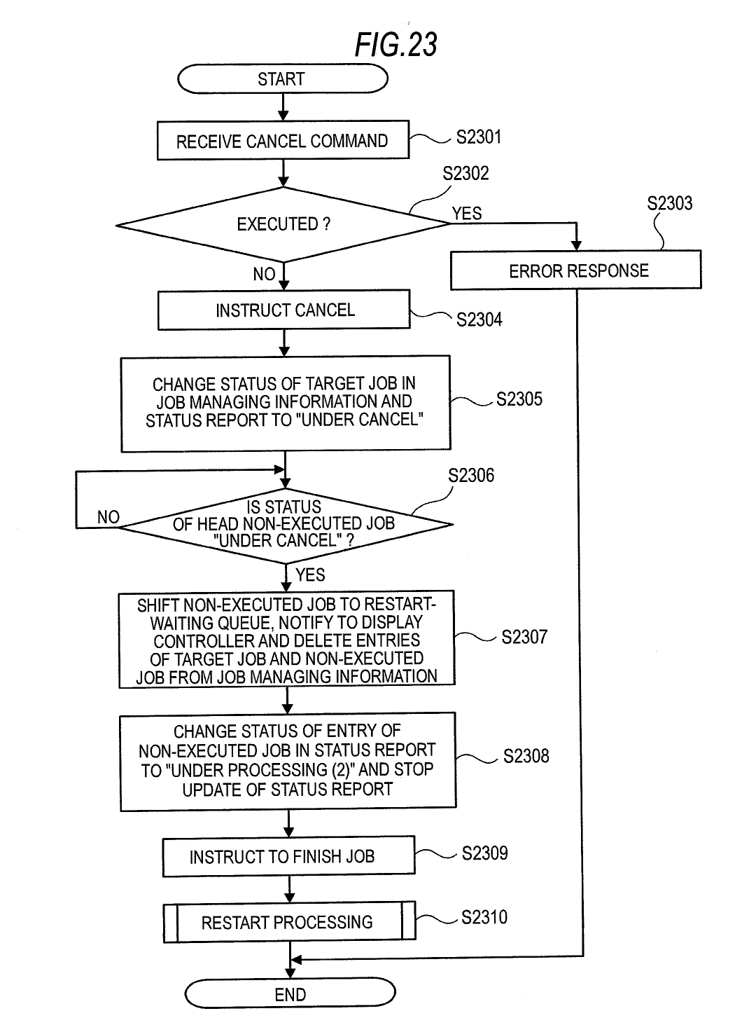

FIG. 23 is a flowchart showing the operation of the job managing unit 221 and the display controller 223 when a cancel command of a print job is received.

In FIG. 23, the operation executed till step 2306 is the same as the operation executed until the step 806 shown in FIG. 8, and thus the description thereof is omitted.

In the job managing information and the status report, after the status of a target job is set to “under cancel”, execution of the print job progresses, and when the canceled print job (target job) is the head of the link job (step 2306), the job managing unit 221 transfers the non-executed job from the executing queue 222a to the restart waiting queue 222b. The job managing unit 221 notifies it to the display controller 223 that the non-executed job is set to “restart waiting state”, and deletes the target job and the entry of the non-executed job from the job managing information (step 2307).

When receiving the notification from the job managing unit 221, the display controller 223 sets the status of the entry of the non-executed job in the status report to “under processing (2)”, and stops the update of the status report (step 2308). Thereafter, the job managing unit 221 instructs the image forming apparatus 100 to finish the execution of the job (step 2309), and in response to this instruction, the image forming apparatus 100 executes the stop processing. Furthermore, the job managing unit 221 executes the restart processing to execute a non-executed job (step 2310).

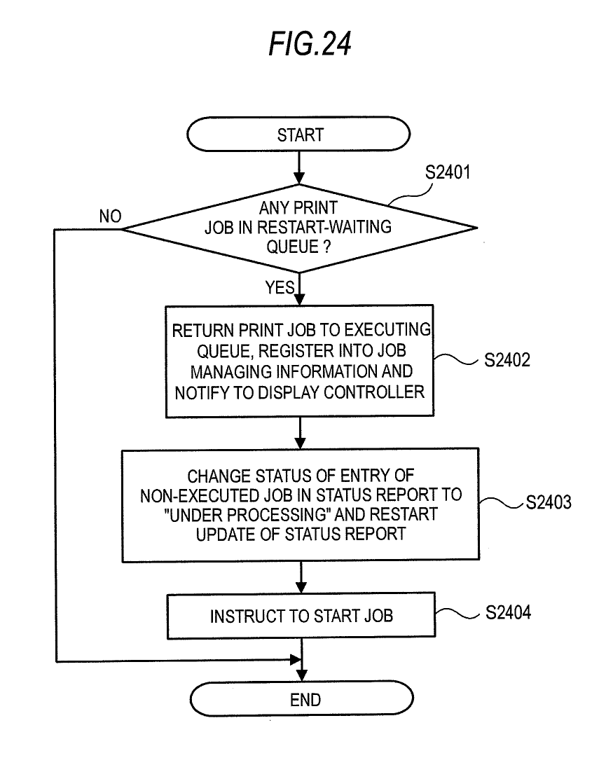

FIG. 24 is a flowchart showing the content of the restart processing of the step 2310 of FIG. 23.

The job managing unit 221 first checks whether a print job is held in the restart waiting queue 222b of the data memory 222 (step 2401). When no print job is held in the restart waiting queue 222b, it means that there does not exist any non-executed job when the execution of the print job is canceled, that is, all the print jobs except for the target job belonging to the link job have been executed, and thus the restart processing is finished.

On the other hand, when a print job is held in the restart waiting queue 222b, the job managing unit 221 returns this print job to the executing queue 222a, and registers the print job into the job managing information (step 2402). This registration is identical to the registration of a normal print job received from the client terminal 300. That is, a link job for the print job returned to the executing queue 222a is created, and this link job and print jobs belonging to the link job are registered in the job managing information.

The display controller 223 changes the status of the entry of the non-executed job in the status report to “under processing”, and restarts the update of the status report (step 2403). Thereafter, the job managing unit 221 instructs the image forming apparatus 100 to start execution of the job (step 2404). In response to this instruction, the image forming apparatus 100 executes the start-up processing, so that execution of a print job is started.

### <Specific Example of Update of Job Managing Information and Status Report>

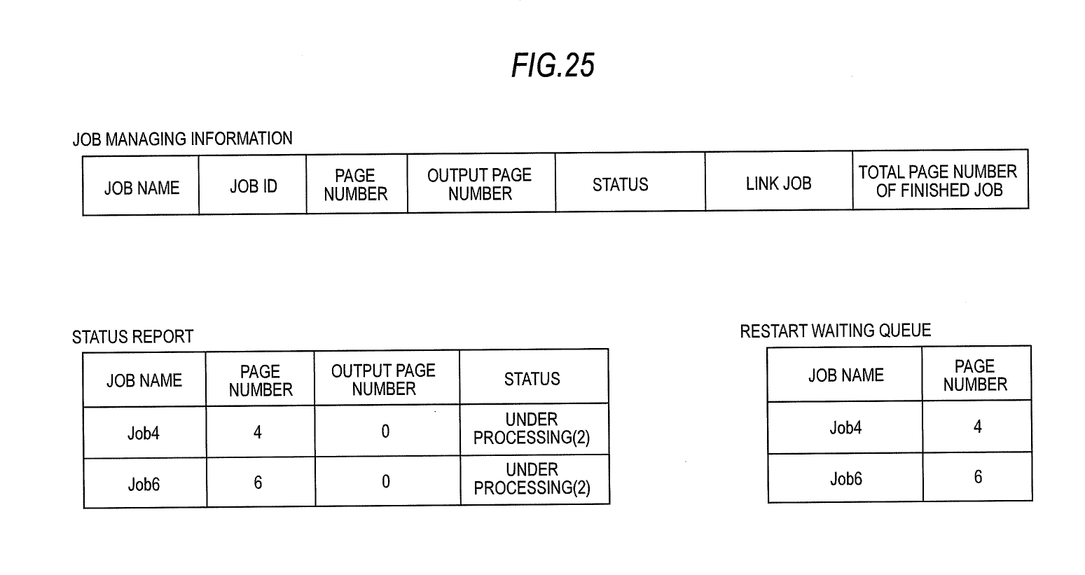

The update operation of the job managing information and the status report will be further described with reference to FIGS. 25 to 27.

First, it is assumed that the update of the job managing information and the status report progresses as in the case of FIGS. 10 to 17. In these operations, the registration content of the job managing information and the display content of the status report are the same as shown in FIGS. 10 to 17.

Under the state of FIG. 17, the status of “Job3” at the head of the print jobs belonging to “renJob1” is set to “under cancel” in the job managing information. Therefore, the job managing unit 221 transfers to the restart waiting queue 222b “Job4” and “Job6” as non-executed jobs whose statuses are “under processing”, and notifies this fact to the display controller 223 as indicated by the steps 2306 and 2307 of FIG. 23. Furthermore, the job managing unit 221 deletes the entries of all the jobs (“renJob1”, “Job3” to “Job6”) from the job managing information.

The display controller 223 receives this notification from the job managing unit 221, changes the statuses of “Job4” and “Job6” to “under processing (2)” as indicated by the step 2308 of FIG. 23, and stops the update of the status report. Therefore, even when the entries of “Job4” and “Job6” are deleted from the job managing information, the status report is not changed. FIG. 25 shows the statuses of the job managing information and the status report and the storage content of the restart waiting queue 222b at this time. As shown in FIG. 25, in the status report, the entries of “Job4” and “Job6” are not deleted, and the status is kept to be “under processing (2)”. Therefore, there is no risk that the user has such a misunderstanding that “Job4” and “Job6” are not executed.

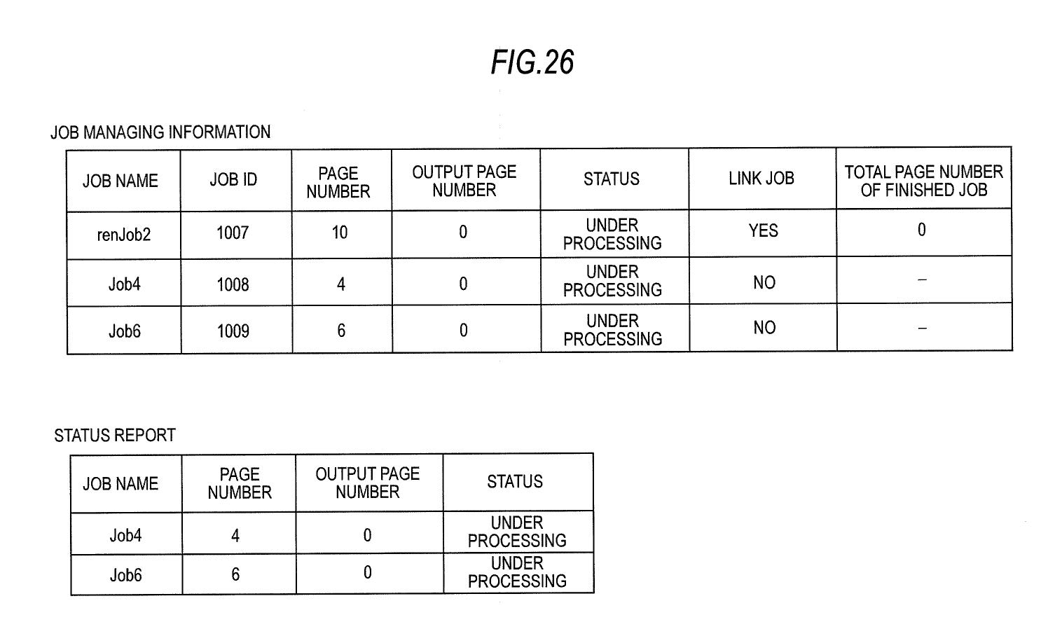

Subsequently, the processing is shifted to the restart processing shown in FIG. 24. Since “Job4” and “Job6” are held in the restart waiting queue 222b, the job managing unit 221 returns these print jobs to the executing queue 222a, registers these print jobs into the job managing information, and notifies this fact to the display controller 223. At this time, the registration of the print jobs into the job managing information is the same as the registration of a normal print job received from the client terminal 300. Accordingly, a new link job “renJob2” for “Job4” and “Job6” is created, and “Job4” and “Job6” are added with new job IDs and registered in the job managing information. FIG. 26 shows the statuses of the job managing information and the status report at this time. Referring to FIG. 26, “Job4” and “Job6” are registered in the job managing information together with the new link job “renJob2”, and new job IDs “1008” and ! 1009” are added to “Job4” and “Job6”.

The display controller 223 receives a notification from the job managing unit 221, and restarts the update of the status report as indicated by the step 2403 of FIG. 24. “Job4” and “Job6” are newly registered in the job managing information, so that the statuses thereof are set to “under processing”. Therefore, as shown in FIG. 26, the display controller 223 changes the statuses of “Job4” and “Job6” of the status report to “under processing”.

Subsequently the job managing unit 221 instructs the image forming apparatus 100 to start execution of jobs, and transmits the data of “Job4” and “Job6” as the data of first to tenth pages of “renJob2” to the image forming apparatus 100. The image forming apparatus 100 executes the start-up processing in response to the start instruction, and then executes “renJob2”.

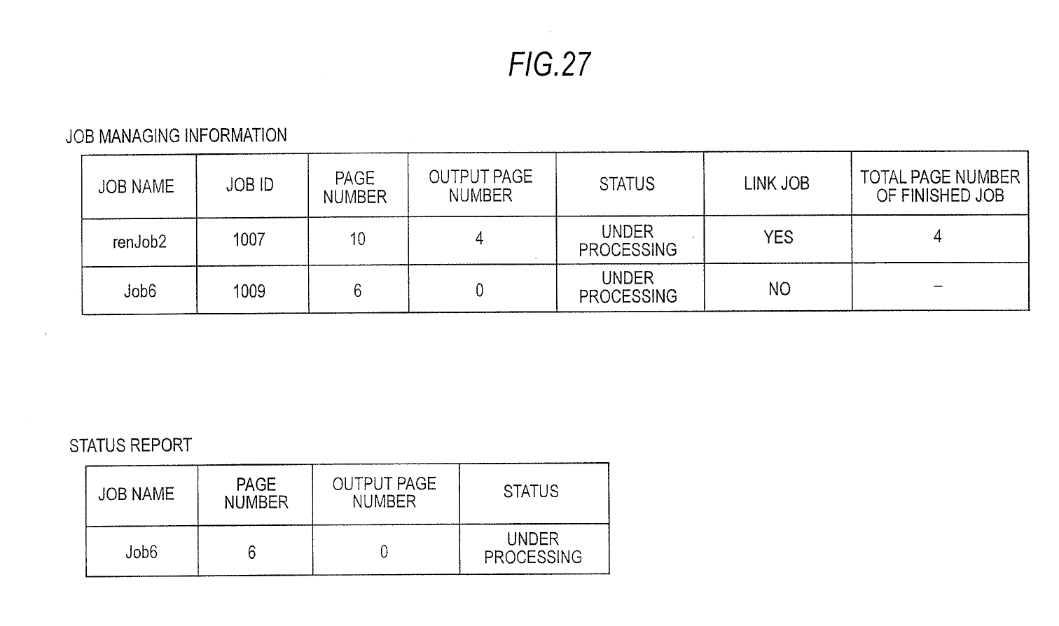

Here, it is assumed that the image forming apparatus 100 completes the output of the first to fourth pages and the job managing unit 221 receives an output completion notification of the first to fourth pages. At this time, the page number of “Job4” is equal to four pages, and the page number of “Job4” is equal to the output page number (in this case, “4”), so that the execution of “Job4” is finished. Therefore, the job managing unit 221 sets the total page number of the finished jobs of “renJob2” to four (the page number of the finished “Job4”), and deletes the entry of “Job4” from the job managing information. In connection with this deletion, the display controller 223 also deletes the entry of “Job4” in the status report. FIG. 27 shows the statuses of the job managing information and the status report at this time.

The technical scope of the present invention is not limited to the exemplary embodiments described above. For example, the items of the job managing information and the status report are not limited to the items shown in FIGS. 5 and 6, and any information may be used insofar as the information is necessary to manage the print jobs and control execution of the print jobs. In addition, the technical scope of the invention includes various modifications or improvements.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments were chose and described in order to best explain the skilled in the art to understand the invention for various exemplary embodiments and with the various modifications as are suited to the particular use contemplated. It is intended that the scope of the invention be defined by the following claims and their equivalents.

What is claimed is:

1. A control apparatus comprising:
an execution controller that links a plurality of print commands with each other, makes an image forming apparatus execute the linked print command as a single print command, cancels execution of a cancel target print command and an unexecuted print command scheduled to be executed after the cancel target print command when a cancel command is issued to some of the plurality of print commands belonging to the linked print command, and then makes the image forming apparatus execute the unexecuted print command; and
a display controller that creates status information representing an execution state of the plurality of print commands and displays the status information on a display,
wherein the display controller distinguishably displays, as the status information concerning the unexecuted print command, at least a first status waiting for execution of the unexecuted print command and a second status waiting for restart of execution of the unexecuted print command after execution of the unexecuted print command has been canceled in connection with cancellation of the cancel target print command.

2. The control apparatus according to claim 1, wherein when the unexecuted print command becomes executable, the display controller shifts the status of the print command displayed in the status information from the second status to the first status.

3. The control apparatus according to claim 2, wherein after canceling the execution of the unexecuted print command, the execution controller issues the unexecuted print command, obtains the unexecuted print command issued by the execution controller and makes the image forming apparatus execute the unexecuted print command.

4. The control apparatus according to claim 3, wherein the execution controller adds identification information to the unexecuted print command issued by the execution control apparatus, and issues the unexecuted print command with the identification information, the identification information allowing the unexecuted print command issued from the execution controller to be distinguished from a print command issued from an external device.

5. The control apparatus according to claim 1, wherein the execution controller has a first queue that holds the print command under an execution-waiting state and a second queue that holds the unexecuted print command whose execution is canceled in connection with the cancel target print command, transfers the unexecuted print command from the first queue to the second queue, returns the unexecuted print command from the second queue to the first queue after execution of the cancel target print command and the unexecuted print command has been canceled, and makes the image forming apparatus execute the unexecuted print command.

6. The control apparatus according to claim 5, wherein the display controller does not update the status information when the unexecuted print command is held in the second queue.

7. An image forming system comprising:
an image forming apparatus that prints and outputs an image according to a print command; and
a control apparatus that manages the print command and controls execution of the print command by the image forming apparatus, links a plurality of the print commands having a common print condition with each other, and makes the image forming apparatus execute the linked print command as a single print command,
wherein the control apparatus includes an execution controller that cancels execution of a cancel target print command and an unexecuted print command scheduled to be executed after the cancel target print command when a cancel command is issued to some of the plurality of linked print command, and then makes the image forming apparatus execute the unexecuted print command; and
a display controller that creates status information representing an execution state of the plurality of print commands and displays the status information on a display, and
wherein the display controller distinguishably displays as the status information concerning the unexecuted print command, at least a first status waiting for execution of the unexecuted print command, and a second status waiting for restart of execution of the unexecuted print command after execution of the unexecuted print command has been canceled in connection with cancellation of the cancel target print command.

8. The image forming system according to claim 7, wherein after canceling the execution of the unexecuted print command, the execution controller issues the unexecuted print command, obtains the issued unexecuted print command and makes the image forming apparatus execute the unexecuted print command.

9. The image forming system according to claim 7, wherein the execution controller has a first queue that holds the print command under an execution-waiting state and a second queue that holds the unexecuted print command whose execution is canceled in connection with the cancel target print command, transfers the unexecuted print command from the first queue to the second queue, returns the unexecuted print command from the second queue to the first queue after execution of the cancel target print command and the unexecuted print command has been canceled, and makes the image forming apparatus execute the unexecuted print command.

10. A computer readable medium storing a program causing a computer to execute a process for control of image forming processing, the process comprising:
linking a plurality of print commands;
making an image forming apparatus execute the linked print command as a single print command;
canceling execution of a cancel target print command and an unexecuted print command scheduled to be executed after the cancel target print command when a cancel command is issued to some of the plurality of print commands belonging to the linked print command;
making the image forming apparatus execute the unexecuted print command;
creating status information representing an execution state of the plurality of print commands and displaying the status information on a display, wherein at least a first status waiting for execution of the unexecuted print command and a second status waiting for restart of execution the unexecuted print command waits after execution of the unexecuted print command has been canceled in connection with cancellation of the cancel target print command are distinguishably displayed as the status information concerning the unexecuted print command.

11. A control method for image processing, comprising:
linking a plurality of print commands;
making an image forming apparatus execute the linked print command as a single print command;
canceling execution of a cancel target print command and an unexecuted print command scheduled to be executed after the cancel target print command when a cancel command is issued to some of the plurality of print commands belonging to the linked print command;
making the image forming apparatus execute the unexecuted print command;
creating status information representing an execution state of the plurality of print commands and displaying the status information on a display, wherein at least a first status waiting for execution of the unexecuted print command and a second status waiting for restart of execution the unexecuted print command waits after execution of the unexecuted print command has been canceled in connection with cancellation of the cancel target print command are distinguishably displayed as the status information concerning the unexecuted print command.
